(19) United States
(12) Patent Application Publication
(10) Pub. No.: US 2025/0380726 A1
(43) Pub. Date: Dec. 18, 2025

(54) FRIED FOOD BATTER MIX AND FRIED FOOD PRODUCTION METHOD

(71) Applicant: Nisshin Seifun Welna Inc., Tokyo (JP)

(72) Inventors: Kensuke NISHI, Tokyo (JP); Hiroshi AMANO, Tokyo (JP); Mitsunori FUJIBE, Tokyo (JP); Toru SHIGEMATSU, Tokyo (JP)

(73) Assignee: Nisshin Seifun Welna Inc., Tokyo (JP)

(21) Appl. No.: 18/835,896

(22) PCT Filed: Mar. 6, 2023
(86) PCT No.: PCT/JP2023/008211

§ 371 Date: Jan. 31, 2025

(30) Foreign Application Priority Data
Mar. 7, 2022 (JP) 2022-034787

(51) Int. Cl. A23L 7/157; A23L 5/10; A23P 20/10

(52) U.S. Cl. CPC A23L 7/157; A23L 5/11; A23P 20/10

(57) ABSTRACT

A batter mix for deep-fried food of the present invention contains a malt-derived ingredient in an amount of 0.01 to 5 mass %, hydrolyzed wheat protein in an amount of 0.01 to 3 mass %, and one or more selected from the group consisting of a cereal flour and a starch in an amount of 50 to 99.98 mass %. Preferably, the batter mix for deep-fried food contains a cereal flour as the one or more selected from the group consisting of a cereal flour and a starch, and the cereal flour at least partially contains a heat-treated wheat flour. A method for producing deep-fried food according to the present invention includes mixing 100 parts by mass of the batter mix for deep-fried food of the present invention with 100 to 500 parts by mass of an aqueous liquid to prepare a batter for deep-fried food, attaching the batter for deep-fried food to the surface of a solid ingredient, and deep-frying the solid ingredient.

### TECHNICAL FIELD

The present invention relates to a batter mix for deep-fried food and a method for producing deep-fried food.

### BACKGROUND ART

Deep-fried food refers to food obtained by cooking various solid ingredients through deep-frying. Deep-fried food includes suage, which is deep-fried food obtained by deep-frying solid ingredients without any coating materials attached thereto, as well as deep-fried food with coating, such as tempura, karaage, breaded and deep-fried food, and fritters, which is obtained by deep-frying solid ingredients with coating materials attached thereto. When a solid ingredient is deep-fried with a coating material attached thereto, due to the presence of the coating material, the solid ingredient inside is heated as if it were steamed and thus has a soft texture and an enhanced savory taste, while the coating material on the surface is heated at a high temperature and thus has a crispy texture and an appetizing flavor of oil, and these textures, taste, and flavor combine together to provide a texture and a flavor that are characteristic of deep-fried food.

Patent Literature 1 discloses a method for producing snack food, the method including, for the purpose of improving texture, kneading a malt extract with wheat, yeast, and water and fermenting the kneaded product before baking and deep-frying. Patent Literature 2 discloses the production of various food products, such as deep-fried food, in which germinated barley is blended in an amount of 20% to 50% of the total ingredients in order to enable intake of functional components, such as GABA and dietary fiber, contained in malt. Patent Literature 3 discloses a batter mix containing: wheat flour: hydrolyzed wheat gluten: pregelatinized wheat starch, pregelatinized potato starch, pregelatinized rice starch, pregelatinized corn starch, pregelatinized tapioca starch, pregelatinized corn starch, or pregelatinized waxy corn starch, either alone or a mixture of two or more; dextrin: glucomannan: an alkaline coagulant, namely, calcium hydroxide, potassium hydroxide, sodium carbonate, calcined eggshell calcium, or calcined shell calcium, either alone or a mixture of two or more; and a basic compound other than these.

### CITATION LIST

### Patent Literature

Patent Literature 1: JP S61-52244A
Patent Literature 2: US 2007/148299A1
Patent Literature 3: JP 2000-125795A

### SUMMARY OF INVENTION

Deep-fried food with coating immediately after cooking has good texture and flavor characteristic of deep-fried food, but as time passes, moisture from a solid ingredient inside the deep-fried food and moisture in the air migrate to the coating, and the crispy texture of the coating decreases. In particular, when deep-fried food is stored in an environment at around normal temperature, that is, 10° C. to 40° C. after being produced, the coating becomes not only soft but also soggy, resulting in a significant loss of its texture. This tendency has been prominent in the cases where produced deep-fried food is stored in a sealed container and then consumed several hours later. No consideration is given to this problem in Patent Literatures 1 to 3.

The present invention relates to a batter mix for deep-fried food that enables efficient production of deep-fried food whose coating maintains a crispy and light texture for a long period of time even when the produced deep-fried food is stored in a sealed environment at around normal temperature.

The present invention provides a batter mix for deep-fried food, comprising a malt-derived ingredient in an amount of 0.01 to 5 mass %, hydrolyzed wheat protein in an amount of 0.01 to 3 mass %, and one or more selected from the group consisting of a cereal flour and a starch in an amount of 50 to 99.98 mass %.

The present invention also provides a method for producing deep-fried food, comprising
mixing 100 parts by mass of a batter mix for deep-fried food with 100 to 500 parts by mass of an aqueous liquid to prepare a batter for deep-fried food, attaching the batter for deep-fried food to a surface of a solid ingredient, and deep-frying the solid ingredient, and
the batter mix for deep-fried food containing
a malt-derived ingredient in an amount of 0.01 to 5 mass %,
hydrolyzed wheat protein in an amount of 0.01 to 3 mass %, and
one or more selected from the group consisting of a cereal flour and a starch in an amount of 50 to 99.98 mass %.

### DESCRIPTION OF EMBODIMENTS

Hereinafter, the present invention will be described based on a preferred embodiment thereof. A batter mix for deep-fried food of the present invention contains a malt-derived ingredient, hydrolyzed wheat protein, and one or more selected from the group consisting of a cereal flour and a starch, in respective predetermined amounts. “Deep-fried food” refers to food obtained by cooking various solid ingredients through deep-frying, and the batter mix for deep-fried food of the present invention is mixed with an aqueous liquid to prepare a batter for deep-fried food, which is then suitably used as a coating material in the production of deep-fried food with a coating on the surface of a solid ingredient.

In the following description, “X to Y [Z]” (X and Y are any desired numbers, and [Z] is a unit) means “X [Z] or more and Y [Z] or less”, unless otherwise specified.

Also, in this specification, the mass of the batter mix for deep-fried food of the present invention and the mass of each ingredient contained in the mix are expressed in terms of solid content. The “mass in terms of solid content” refers to the mass of components contained in the batter mix for deep-fried food of the present invention, or each of the various ingredients thereof, when dried to an equilibrium moisture content at 25° C. The mass in terms of solid content can be calculated by drying each of the various ingredients, or the batter mix for deep-fried food in which the various ingredients are mixed, to an equilibrium moisture content at 25° C. and then measuring the mass of the mix itself or measuring the mass of each of the ingredients or contained components isolated from the mix.

If the content of an ingredient is known in advance before the batter mix for deep-fried food is prepared, the content of that ingredient is equivalent to the mass of the ingredient when it reaches an equilibrium moisture content at 25° C., and therefore, the mass of an ingredient used may be expressed as the content of the ingredient in the batter mix for deep-fried food of the present invention.

One of the features of the batter mix for deep-fried food of the present invention is that it contains a malt-derived ingredient and hydrolyzed wheat protein. The inventors of the present invention unexpectedly found that, with these ingredients contained in the batter mix for deep-fried food, even when the produced deep-fried food is stored in a sealed container, the coating is prevented from becoming soggy and can develop and maintain a crispy texture for a long period of time.

The term “malt-derived ingredient” as used herein refers to an ingredient obtained by subjecting malt, which is germinated seeds of wheat, barley, or a similar grain, to any desired treatment (e.g., one or more of drying, grinding, extraction, and the like), and specifically encompasses ground malt obtained by dry-grinding malt and a malt extract obtained by extracting components from the ground malt, or unground malt, using an aqueous liquid. Also, the term “germinated” refers to a state in which at least either sprouts or roots extend from seeds.

Unprocessed malt (e.g., unground malt) itself is excluded from the malt-derived ingredient. In addition, the malt-derived ingredient is excluded from “a cereal flour and a starch” as used herein.

As the “wheat, barley, or a similar grain” from which the malt-derived ingredient is obtained, any one or more of barley, wheat, rye, oats, and the like can be used. Of these, barley is more preferable because, when barley is used, the coating of the produced deep-fried food develops a good, crispy texture for a long period of time and thus has excellent brittleness when chewed.

In the present invention, the malt is used preferably within 120 hours, more preferably after 1 to 108 hours, and even more preferably after 2 to 96 hours, from the point in time when it has been confirmed that at least either sprouts or roots extend from the seeds. As a result of using such malt, deep-fried food whose coating has an even crispier texture can be obtained.

When ground malt is used as the malt-derived ingredient, from the viewpoint of effectively obtaining a flavor and a texture characteristic of deep-fried food, it is preferable to use malt from which roots have been removed, and it is more preferable to use ground, dried malt from which roots have been removed. Ground malt is typically in the form of a dry powder, that is, in powder form.

A grinding method used in the art can be employed as the grinding method to obtain the ground malt. As an example of the grinding method, dried malt can be fed into a known grinding apparatus, such as a blender or a mill, and ground to a particle size that passes through a sieve with an opening size of 1 mm.

When a malt extract is used as the malt-derived ingredient, an extraction method used in the art can be employed to extract the malt extract. As an example of the extraction method, ground malt obtained using the above-described method is immersed in an aqueous liquid in a volume ratio of preferably 100% to 500% and is allowed to stand, or subjected to an operation such as shaking or stirring as necessary, in a non-heated state or a heated state, to obtain an extract solution into which components derived from malt are extracted.

The extraction temperature may be about 5° C. to 100° C. for the entire extraction system, and the extraction time may be about 30 minutes to 24 hours.

As the aqueous liquid, any aqueous liquid that can be used for food can be used. For example, any one of clean water, acidic water, alkaline water, and alcohols such as ethanol may be used alone, or any mixture of two or more thereof may be used.

As the malt extract, the extract solution may be directly used in liquid form, or may be used in the form of a powder obtained by removing the aqueous liquid from the extract solution through drying, concentrating, and the like. When the extract solution is used in liquid form, the extract solution may be used attached to or penetrating into other ingredients constituting the batter mix for deep-fried food of the present invention.

The content of the malt-derived ingredient in the batter mix for deep-fried food of the present invention is 0.01 to 5 mass %, preferably 0.04 to 4 mass %, and more preferably 0.1 to 3 mass %, in terms of solid content, relative to the total mass of the batter mix for deep-fried food. With the content of the malt-derived ingredient set in the above-described range, the resulting deep-fried food can favorably develop a crispy and light texture characteristic of deep-fried food even after a lapse of time after being cooked, or even after being reheated using a microwave oven or the like, and also can maintain a good texture for a long period of time. In addition, the content of the malt-derived ingredient set in the above-described range is advantageous in that the deep-fried food can have a favorably brittle texture when chewed.

From the viewpoints of making it easy to successfully adjust the content of the malt-derived ingredient, enhancing the ease of operation such as uniform mixing during the production of the batter mix for deep-fried food, and reducing deterioration of constituent components to thereby obtain a high-quality batter mix for deep-fried food and high-quality deep-fried food, it is preferable to use a malt-derived ingredient that is in powder form at normal temperature and normal pressure (25° C., 1 atm.), or in other words, in an environment in which the malt-derived ingredient is usually used. That is to say, as the malt-derived ingredient, it is preferable to use ground malt alone, a malt extract powder alone, or a combination of these. When ground malt and a malt extract powder are used in combination, the above-described content of the malt-derived ingredient is calculated based on the total mass of the respective powders.

Preferably, the batter mix for deep-fried food of the present invention has amylase activity at or above a certain level, regardless of whether the malt-derived ingredient used in the mix is a ground product or an extract, because this enables deep-fried food whose coating has an excellent, crispy and light texture to be obtained with high productivity.

More particularly, the amylase activity per 100 g of the batter mix for deep-fried food is preferably 5 to 250 U, and more preferably 15 to 150 U. The amylase activity can be appropriately adjusted by changing the type of the malt-derived ingredient (i.e., whether it is a ground product or an extract), the form of the malt-derived ingredient, or the content of the malt-derived ingredient. Specifically, when a malt-derived ingredient having an amylase activity of 500 U/g is used, when 0.1 g (0.1 mass %) of the malt-derived ingredient is blended in 100 g of the batter mix for deep-fried food, the amylase activity per 100 g of the batter mix for deep-fried food is calculated to be 50 U.

Amylase activity can be measured using a commercially available α-amylase assay kit (manufactured by Kikkoman Biochemifa Company, for example).

The term “hydrolyzed wheat protein” as used herein refers to a decomposed product of protein derived from wheat seeds. Examples of the protein derived from wheat seeds include gliadin, glutenin, and gluten. As a means for decomposing the protein derived from wheat seeds, known methods can be employed, and examples thereof include an enzymatic decomposition method, a thermal decomposition method, an acidic decomposition method, and an alkaline decomposition method. Among these methods, an enzymatic decomposition method is preferred because it does not degrade the flavor of food.

The hydrolyzed wheat protein used in the present invention preferably has an average molecular weight of 1000 to 50000 Da, and more preferably 3000 to 30000 Da. If the average molecular weight of the hydrolyzed wheat protein is too small, bitterness and astringency may be increased, and if the average molecular weight is too large, the hydrolyzed wheat protein may not dissolve in water.

The average molecular weight of the hydrolyzed wheat protein herein refers to a weight-average molecular weight and can be determined by gel filtration chromatography.

Examples of enzymes used in the enzymatic decomposition method, which is a preferred hydrolytic enzymatic method, include endo- or exo-type proteolytic enzymes and peptidolytic enzymes applicable to food, and any one of these enzymes may be used alone, or two or more thereof may be used in combination. The conditions of the enzymatic treatment, such as, for example, the type of the enzyme used as well as the temperature and time of the enzymatic treatment, are not particularly limited, but are preferably such conditions under which hydrolyzed wheat protein having the above-described average molecular weight can be obtained. For example, the enzymatic treatment may be performed using a method and conditions disclosed in JP 2001-231488A, JP 2018-74967A, or Japanese Patent No. 2884009. In addition, the hydrolyzed wheat protein used in the present invention may also be prepared by combining a plurality of types of hydrolyzed wheat protein treated under different conditions.

Moreover, a commercially available product can also be employed as the hydrolyzed wheat protein used in the present invention. Examples of such products include Glutamine Peptide GP-1 (manufactured by Nisshin Pharma Inc.) and Blavono W (manufactured by OKUNO Chemical Industries Co., Ltd.).

The content of the hydrolyzed wheat protein in the batter mix for deep-fried food of the present invention is 0.01 to 3 mass %, preferably 0.04 to 2 mass %, and more preferably 0.1 to 1 mass %, in terms of solid content, relative to the total mass of the batter mix for deep-fried food. With the content of the hydrolyzed wheat protein set in the above-described range, the resulting deep-fried food can favorably develop a crispy and light texture characteristic of deep-fried food even after a lapse of time after being cooked, or even after being reheated using a microwave oven or the like, and also can maintain a good texture for a long period of time. In addition, the content of the hydrolyzed wheat protein set in the above-described range is advantageous in that the deep-fried food can have a favorably brittle texture when chewed.

The batter mix for deep-fried food of the present invention further contains a cereal flour and/or a starch, in addition to the above-described malt-derived ingredient and hydrolyzed wheat protein.

There is no particular limitation on the cereal flour used in the present invention, as long as it can be used for food, and examples include ground products of ungerminated seeds of cereal grains including wheat flour such as soft wheat flour, medium wheat flour, semi-strong wheat flour, strong wheat flour, and durum flour, barley flour, rice flour, and the like. Any one of these cereal flours may be used alone, or any mixture of two or more thereof may be used. Cereal flours are typically in powder form at normal temperature and normal pressure.

There is no particular limitation on the starch used in the present invention, as long as it can be used for food, and, for example, a common starch, such as corn starch, wheat starch, tapioca starch, sweet potato starch, potato starch, or modified starch, may be used alone, or any mixture of two or more thereof may be used. Starches are typically in powder form at normal temperature and normal pressure.

Note that, as described above, the malt-derived ingredient contained in the batter mix for deep-fried food is excluded from the cereal flour and the starch.

The content of the cereal flour and/or starch is 50 to 99.98 mass %, preferably 60 to 99.92 mass %, more preferably 70 to 99.8 mass %, and even more preferably 80 to 99.5 mass %, relative to the total mass of the batter mix for deep-fried food. When both a cereal flour and a starch are contained, the aforementioned content is the total amount thereof. With the content of the cereal flour and/or starch set in the above-described range, deep-fried food obtained using the batter mix for deep-fried food is unlikely to be too firm or too soft, and thus has excellent flavor and texture characteristic of deep-fried food. In addition, a crispy and light texture characteristic of deep-fried food can be favorably developed for a long period of time even after a lapse of time after the deep-fried food has been cooked, or even after the deep-fried food is reheated.

From the viewpoint of improving the flavor, the texture, and the appearance, such as color, of the coating obtained from the batter mix for deep-fried food and thereby enhancing the palatability of the produced deep-fried food, it is preferable that, out of the cereal flour and/or starch, a cereal flour, or more preferably wheat flour, is used as the main ingredient. When wheat flour is used, the ratio of wheat flour to the total mass of the cereal flour and any starch contained is preferably 60 mass %, more preferably 70 mass % or more, and even more preferably 80 to 100 mass %.

When wheat flour is used as the cereal flour, it is preferable that the cereal flour at least partially contains wheat flour that has been heat treated (hereinafter also referred to as heat-treated wheat flour) as the wheat flour. When the batter mix for deep-fried food contains heat-treated wheat flour, deep-fried food obtained using the mix can have a crispy and light texture and can also have a more favorable brittle texture when chewed.

When wheat flour is used as the cereal flour, part or all of the wheat flour used may be heat-treated wheat flour. That is, the cereal flour may be partially or entirely constituted by heat-treated wheat flour. The ratio of the heat-treated wheat flour to the total mass of wheat flour contained in the batter mix for deep-fried food is preferably 50 mass % or more, more preferably 70 mass % or more, and even more preferably 80 to 100 mass %.

As the heat-treated wheat flour, heat-treated wheat flour obtained by grinding unheated and ungerminated wheat seeds into wheat flour and then subjecting the wheat flour to heat treatment or heat-treated wheat flour obtained by subjecting unheated and ungerminated wheat seeds to heat treatment and then grinding and milling the seeds may be used. In the following description, unheated wheat flour and wheat seeds may be collectively referred to as “heating target”.

The aforementioned heat treatment may be dry heat treatment or wet heat treatment. Whether in the dry heat treatment or in the wet heat treatment, heating is preferably performed at 80 to 120° C. for 5 to 120 seconds.

The dry heat treatment is a heating process in which the heating target is heated under conditions without adding moisture, and is performed while actively evaporating moisture in the heating target. The dry heat treatment can be carried out by, for example, heating the heating target in an oven, heating the heating target in a roasting kiln, heating the heating target using a constant temperature bath, heating the heating target by blowing hot air against it, leaving the heating target in a high temperature and low humidity environment, or the like. Note that a process in which wheat flour to which water has been added, for example, is heated by blowing warm air against the wheat flour is not included in the dry heat treatment because heat is not sufficiently applied to the heating target due to the latent heat of vaporization of moisture.

The wet heat treatment is a heating process in which the heating target is heated while maintaining moisture in the heating target or supplying moisture from the outside. In the wet heat treatment, water or steam such as saturated steam can be supplied and used. The amount of moisture supplied in the wet heat treatment is preferably 5 to 50 parts by mass relative to 100 parts by mass of the heating target.

There is no particular limitation on the heating method used in the wet heat treatment, and examples thereof include: a method in which moisture is added to the heating target, and then a heat medium such as hot air is brought into direct contact with the heating target in a sealed environment: a method in which the heating target is heated by the latent heat of condensation by bringing hot steam into contact with the heating target; and a method in which the heating target is heated in a high humidity atmosphere. There is no particular limitation on the apparatus used for the wet heat treatment, and, for example, an autoclave, a steam oven, a single- or double-screw extruder, and the like can be used.

The batter mix for deep-fried food of the present invention may consist of a malt-derived ingredient, hydrolyzed wheat protein, and a cereal flour and/or a starch, or may further contain an additional ingredient in addition to these ingredients, if necessary. When an additional ingredient is further contained, the content of the additional ingredient is preferably about 20 mass % or less relative to the total mass of the batter mix for deep-fried food.

As the additional ingredient that may be contained in the batter mix for deep-fried food, any ingredient that can be usually used in the production of this type of batter mix for deep-fried food can be used. Examples of such additional ingredients include: saccharides other than starch, such as sucrose, fructose, and dextrin: proteins such as milk protein and soybean protein: seasonings such as salt and soy sauce: spices such as pepper; oils/fats: thickeners; leavening agents; emulsifiers; and the like, and one or two or more of these ingredients may be appropriately selected and used according to the type of deep-fried food to be produced, and the like.

The batter mix for deep-fried food of the present invention is a mixture that is solid at normal temperature and normal pressure, and is preferably in powder form. To produce a batter mix for deep-fried food in powder form, for example, a malt-derived ingredient in powder form, hydrolyzed wheat protein in powder form, and a powder of a cereal flour and/or a starch can be dry-mixed. Mixing of the powders can be performed using a known mixing apparatus such as a blender.

During the production of deep-fried food, the batter mix for deep-fried food of the present invention is used as a batter, which is a mixture of the mix with an aqueous liquid. The batter is attached to the surface of a solid ingredient, the solid ingredient with the batter attached is then deep-fried, and thus, deep-fried food can be obtained. Therefore, the present invention also provides a method for producing deep-fried food by using a batter made from the batter mix for deep-fried food of the present invention. Hereinafter, the method for producing deep-fried food of the present invention will be described.

When making a batter from the batter mix for deep-fried food of the present invention, it is preferable to mix 100 parts by mass of the batter mix for deep-fried food of the present invention with 100 to 500 parts by mass of an aqueous liquid. The batter is attached to the surface of a solid ingredient. If necessary, breadcrumbs or the like are further attached to the surface of the batter attached to the surface of the solid ingredient. Then, the solid ingredient is deep-fried. Thus, deep-fried food having a coating on the surface of the solid ingredient can be obtained.

More specifically, the amount of aqueous liquid used can be appropriately adjusted according to the type of the solid ingredient and the like, and preferably 100 to 500 parts by mass, or more preferably 110 to 350 parts by mass, of an aqueous liquid at 25° C. is used relative to 100 parts by mass of the batter mix for deep-fried food in terms of solid content. When the aqueous liquid is mixed in the above-described ratio, a suitable thickness of the batter for deep-fried food can be attached to the surface of the solid ingredient in one operation, and the ease of operation during the production of deep-fried food is thus excellent. Furthermore, the produced deep-fried food can develop a crispy and crunchy texture.

A liquid for eating and drinking can be used as the aqueous liquid, and specific examples include clean water and liquids other than clean water, such as milk, liquid egg, stock, and broth. Any one of these liquids may be used alone, or two or more thereof may be used in combination. In addition to the aqueous liquid, a small amount of oil/fat may also be used as necessary.

There is no particular limitation on the solid ingredient used to produce deep-fried food, and, for examples, various solid ingredients can be used, including meats such as chicken, pork, beef, lamb/mutton, and goat meat: processed meat products such as sausages, ham, and bacon: seafood such as squid, shrimp/prawn, and horse mackerel: processed seafood products such as fish pastes; and vegetables. The solid ingredient may be seasoned with a seasoning and a spice, or a dredging flour, such as soft wheat flour or a starch powder, may be attached to the surface of the solid ingredient, if necessary, before the batter is attached to the solid ingredient.

The present invention can be applied to the production of various types of deep-fried food with coatings, and is particularly suitable for the production of tempura, fritters, breaded and deep-fried food, karaage, and corn dogs, and more particularly suitable for the production of deep-fried food in which the amount of coating is relatively large compared to the amount of solid ingredient, such as tempura and fritters.

### EXAMPLES

Hereinafter, the present invention will be described in further detail based on examples, but the present invention is not limited to the examples given below. The content of each ingredient given below is based on the mass in terms of solid content. Also, blank areas in tables below indicate “not contained” or “not evaluated”.

### Production Examples 1 to 3

Hydrolyzed wheat protein was produced according to the following procedures using gluten as wheat protein.

In a reaction vessel, 180 kg of wheat gluten (“Wheat Gluten” manufactured by NICHIGA) was suspended in 1000 L of ion-exchanged water, the suspension was heated to 45° C., then 400 g of protease (“Protease M Amano” manufactured by Amano Pharmaceutical Co., Ltd.) was added, and the mixture was stirred at 45° C. for 3 hours (Production Example 3), 5 hours (Production Example 2), or 7 hours (Production Example 1) to carry out a hydrolysis reaction. Subsequently, the reaction solution was kept at 80° C. for 20 minutes to deactivate the protease, and then cooled to 45° C. To this reaction solution was added 10 kg of activated carbon, and stirring was performed for 30 minutes to cause the activated carbon to adsorb impurities, which was then removed by filtration. The filtrate was collected and concentrated under reduced pressure until the Brix value reached 20 to 40, and then sterilized through heating at 110° C. for 20 seconds using a plate heater, followed by spray-drying using a spray dryer under conditions at an inlet air temperature of 160° C. and an outlet air temperature of 80° C. Thus, hydrolyzed gluten in powder form was obtained.

The average molecular weight of the obtained hydrolyzed gluten was determined through measurement using gel filtration chromatography. The column used was “Bio-Sil SEC 125-5” manufactured by Bio-Rad Laboratories, Inc., Japan. The measurement conditions were as follows: measurement wavelength: 280 nm: eluent: 0.2 mM phosphate buffer (pH 6.0, 0.1% SDS); and flow rate: 0.2 mL/min. Also, ovalbumin (molecular weight: 44000 Da), myoglobulin (molecular weight: 17000 Da), and vitamin B12 (molecular weight: 1350 Da) were used as standards for molecular weight. The weight-average molecular weight MW was determined from the chromatogram obtained, and was found to be 7600 Da (Production Example 1), 16000 Da (Production Example 2), or 31800 Da (Production Example 3).

### Production Example 4

Hydrolyzed soybean protein having a weight-average molecular weight MW of 9200 Da was obtained in the same manner as in Production Example 1, except that soybean protein (powdered soybean protein, manufactured by Fuji Oil Co., Ltd.) was used instead of wheat gluten.

### Examples 1 to 5 and Comparative Examples 1 to 6

Powdered batter mixes for deep-fried food were produced by mixing ingredients so as to satisfy compositions shown in Table 1 below. The ingredients used are listed below.

### <Malt-Derived Ingredient>

Ground malt: Powder of germinated barley seeds, manufactured by Oriental Yeast Co., Ltd., α-amylase activity: 500 U/g

### <Hydrolyzed Protein>

Hydrolyzed wheat protein: Production Examples 1 to 3
Hydrolyzed soybean protein: Production Example 4

### <Cereal Flour>

Wheat flour: Soft wheat flour (“Flour” manufactured by Nisshin Seifun Welna Inc.: non-heat-treated wheat flour)
Heat-treated wheat flour: Obtained by adding 15 parts by mass of water to 100 parts by mass of soft wheat flour (“Flour” manufactured by Nisshin Seifun Welna Inc.), then filling the mixture into a pouch bag, and subjecting it to wet heat treatment at 120° C. for 60 seconds.

### <Starch>

Corn starch: Corn starch (manufactured by Tomizawa Shouten)

### <Additional Ingredient>

Leavening agent: Baking powder (manufactured by OKUNO Chemical Industries Co., Ltd.)

### Test Example 1

A batter was produced by mixing 100 parts by mass of the batter mix for deep-fried food obtained in each of the examples and comparative examples with 160 parts by mass of clean water.

Peeled shrimps with tails on (20 g/shrimp) were used as solid ingredients. After removing moisture from the surface of the solid ingredients using kitchen paper, a dredging flour (soft wheat flour, “Flour” manufactured by Nisshin Seifun Welna Inc.) was attached to the surface of each solid ingredient, and then the surface of the peeled shrimp was entirely coated with the batter. Thus, solid ingredients coated with the batter were obtained.

The solid ingredients coated with the batter were placed into an oil tank at 170° C. and deep-fried for 2 minutes and 30 seconds to produce deep-fried food (shrimp tempura) with coatings on the surface of the solid ingredients.

The shrimp tempura immediately after production, and the shrimp tempura after being left until slightly cooled after production, then put in a plastic tray, sealed with plastic wrap, and stored at 25° C. for 4 hours, were eaten by ten expert panelists, and the texture of the deep-fried food at that time was evaluated based on the following evaluation criteria. The results of the evaluation are shown in Table 1 below as the arithmetic mean values of evaluation scores given by the ten panelists.

<Evaluation criteria for texture of tempura>
5 points: Very good, the coating is very crispy.
4 points: Good, the coating is crispy.
3 points: Acceptable texture, the coating has soft portions, but yet has a crispy texture overall.
2 points: Poor, the coating lacks crispness and is soft.
1 point: Very poor, the coating has no crispness and is soft and soggy.

TABLE 1

| Composition of mix | Example | | | | | Comparative Example | | | | | |
|---|---|---|---|---|---|---|---|---|---|---|---|
| (mass %) | 1 | 2 | 3 | 4 | 5 | 1 | 2 | 3 | 4 | 5 | 6 |
| Malt-derived ingredient | 0.3 | 0.3 | 0.3 | 0.3 | 0.3 | 0.3 | 0.3 | 0.3 | 0.3 | 0.5 | |
| Hydrolyzed wheat protein of | 0.2 | 0.2 | 0.2 | | | | | | | | 0.5 |
| Production Example 1 | | | | | | | | | | | |
| Hydrolyzed wheat protein of | | | | 0.2 | | | | | | | |
| Production Example 2 | | | | | | | | | | | |
| Hydrolyzed wheat protein of | | | | | 0.2 | | | | | | |
| Production Example 3 | | | | | | | | | | | |
| Wheat gluten | | | | | | 0.2 | 2.0 | | | | |
| Hydrolyzed soybean protein | | | | | | | | 0.2 | 2.0 | | |
| of Production Example 4 | | | | | | | | | | | |
| Corn starch | | 29 | 39 | | | | | | | | |
| Leavening agent | 1.5 | 1.5 | 1.5 | 1.5 | 1.5 | 1.5 | 1.5 | 1.5 | 1.5 | 1.5 | 1.5 |
| Wheat flour | Balance | Balance | Balance | Balance | Balance | Balance | Balance | Balance | Balance | Balance | Balance |
| Total | 100 | 100 | 100 | 100 | 100 | 100 | 100 | 100 | 100 | 100 | 100 |
| Texture of tempura | 4.4 | 4.3 | 4.2 | 4.4 | 4.2 | 4.0 | 3.9 | 3.8 | 3.6 | 4.2 | 4.1 |
| immediately after | | | | | | | | | | | |
| production | | | | | | | | | | | |
| Texture of tempura 4 hours | 4.1 | 4.0 | 3.7 | 4.1 | 3.8 | 2.7 | 2.5 | 2.5 | 2.3 | 2.7 | 2.5 |
| after production | | | | | | | | | | | |

### Examples 6 to 21 and Comparative Examples 7 to 10

Powdered batter mixes for deep-fried food were produced in the same manner as in Example 1, except that the amount of the malt-derived ingredient was changed as shown in Table 2. Also, powdered batter mixes for deep-fried food were produced in the same manner as in Example 1, except that the amount of the hydrolyzed wheat protein was changed as shown in Table 3. With use of these batter mixes, batters were prepared, and shrimp tempura was produced and evaluated, as in Test Example 1. Tables 2 and 3 show the results. Note that Tables 2 and 3 show the results of Example 1 again.

TABLE 2

| | Comparative | | | | | | | | | | Comparative |
|---|---|---|---|---|---|---|---|---|---|---|---|
| Composition of mix | Example | Example | | | | | | | | | Example |
| (mass %) | 7 | 6 | 7 | 8 | 1 | 9 | 10 | 11 | 12 | 13 | 8 |
| Malt-derived | 0.005 | 0.01 | 0.04 | 0.1 | 0.3 | 1 | 2 | 3 | 4 | 5 | 6 |
| ingredient | | | | | | | | | | | |
| Hydrolyzed wheat | 0.2 | 0.2 | 0.2 | 0.2 | 0.2 | 0.2 | 0.2 | 0.2 | 0.2 | 0.2 | 0.2 |
| protein of | | | | | | | | | | | |
| Production Example | | | | | | | | | | | |
| 1 | | | | | | | | | | | |
| Leavening agent | 1.5 | 1.5 | 1.5 | 1.5 | 1.5 | 1.5 | 1.5 | 1.5 | 1.5 | 1.5 | 1.5 |
| Wheat flour | Balance | Balance | Balance | Balance | Balance | Balance | Balance | Balance | Balance | Balance | Balance |
| Total | 100 | 100 | 100 | 100 | 100 | 100 | 100 | 100 | 100 | 100 | 100 |
| Texture of tempura | 4 | 4.2 | 4.2 | 4.3 | 4.4 | 4.4 | 4.3 | 4.3 | 4.2 | 4.1 | 3.8 |
| immediately after | | | | | | | | | | | |
| production | | | | | | | | | | | |
| Texture of tempura | 2.5 | 3.6 | 3.9 | 4 | 4.1 | 4.2 | 4.1 | 4 | 3.8 | 3.5 | 2.4 |
| 4 hours after | | | | | | | | | | | |
| production | | | | | | | | | | | |

TABLE 3

| | Comparative | | | | | | | | | | Comparative |
|---|---|---|---|---|---|---|---|---|---|---|---|
| Composition of mix | Example | Example | | | | | | | | | Example |
| (mass %) | 9 | 14 | 15 | 16 | 1 | 17 | 18 | 19 | 20 | 21 | 10 |
| Malt-derived | 0.3 | 0.3 | 0.3 | 0.3 | 0.3 | 0.3 | 0.3 | 0.3 | 0.3 | 0.3 | 0.3 |
| ingredient | | | | | | | | | | | |
| Hydrolyzed wheat | 0.005 | 0.01 | 0.04 | 0.1 | 0.2 | 0.4 | 0.7 | 1 | 2 | 3 | 4 |
| protein of | | | | | | | | | | | |
| Production Example | | | | | | | | | | | |
| 1 | | | | | | | | | | | |
| Leavening agent | 1.5 | 1.5 | 1.5 | 1.5 | 1.5 | 1.5 | 1.5 | 1.5 | 1.5 | 1.5 | 1.5 |
| Wheat flour | Balance | Balance | Balance | Balance | Balance | Balance | Balance | Balance | Balance | Balance | Balance |
| Total | 100 | 100 | 100 | 100 | 100 | 100 | 100 | 100 | 100 | 100 | 100 |
| Texture of tempura | 4 | 4.2 | 4.2 | 4.3 | 4.4 | 4.4 | 4.3 | 4.3 | 4.2 | 4.1 | 3.8 |
| immediately after | | | | | | | | | | | |
| production | | | | | | | | | | | |
| Texture of tempura | 2.6 | 3.7 | 3.9 | 4.1 | 4.1 | 4.2 | 4.1 | 4.1 | 4 | 3.9 | 2.7 |
| 4 hours after | | | | | | | | | | | |
| production | | | | | | | | | | | |

### Examples 22 to 27

Powdered batter mixes for deep-fried food were produced in the same manner as in Example 1, except that the wheat flour and the heat-treated wheat flour were used according to compositions shown in Table 4 below. With use of these batter mixes, batters were prepared, and shrimp tempura was produced and evaluated, as in Test Example 1. Table 4 below shows the results. Note that Table 4 shows the results of Example 1 again.

TABLE 4

| Composition of mix | Example | | | | | | |
|---|---|---|---|---|---|---|---|
| (mass %) | 1 | 22 | 23 | 24 | 25 | 26 | 27 |
| Malt-derived | 0.3 | 0.3 | 0.3 | 0.3 | 0.3 | 0.3 | 0.3 |
| ingredient | | | | | | | |
| Hydrolyzed wheat | 0.2 | 0.2 | 0.2 | 0.2 | 0.2 | 0.2 | 0.2 |
| protein of Production | | | | | | | |
| Example 1 | | | | | | | |
| Leavening agent | 1.5 | 1.5 | 1.5 | 1.5 | 1.5 | 1.5 | 1.5 |
| Wheat flour | 98 | 59 | 49 | 39 | 29 | 19 | |
| Heat-treated wheat | | 39 | 49 | 59 | 69 | 79 | 98 |
| flour | | | | | | | |
| Total | 100 | 100 | 100 | 100 | 100 | 100 | 100 |
| Texture of tempura | 4.4 | 4.4 | 4.6 | 4.7 | 4.8 | 4.9 | 4.9 |
| immediately after | | | | | | | |
| production | | | | | | | |
| Texture of tempura 4 | 4.1 | 4.1 | 4.3 | 4.4 | 4.5 | 4.7 | 4.7 |
| hours after production | | | | | | | |

### INDUSTRIAL APPLICABILITY

According to the present invention, it is possible to efficiently produce deep-fried food whose coating maintains a crispy and light texture for a long period of time even when the produced deep-fried food is stored in a sealed environment at around normal temperature.

1. A batter mix for deep-fried food, comprising
a malt-derived ingredient in an amount of 0.01 to 5 mass %,
hydrolyzed wheat protein in an amount of 0.01 to 3 mass %, and
one or more selected from the group consisting of a cereal flour and a starch in an amount of 50 to 99.98 mass %.

2. The batter mix for deep-fried food according to claim 1, wherein the malt-derived ingredient is in powder form.

3. The batter mix for deep-fried food according to claim 1, wherein the batter mix comprises the cereal flour, and
the cereal flour at least partially contains a heat-treated wheat flour.

4. A method for producing deep-fried food, comprising
mixing 100 parts by mass of a batter mix for deep-fried food with 100 to 500 parts by mass of an aqueous liquid to prepare a batter for deep-fried food, attaching the batter for deep-fried food to a surface of a solid ingredient, and
deep-frying the solid ingredient, and
the batter mix for deep-fried food containing
a malt-derived ingredient in an amount of 0.01 to 5 mass %,
hydrolyzed wheat protein in an amount of 0.01 to 3 mass %, and
one or more selected from the group consisting of a cereal flour and a starch in an amount of 50 to 99.98 mass %.

5. The method for producing deep-fried food according to claim 4, wherein the batter mix contains the cereal flour, and
the cereal flour at least partially contains a heat-treated wheat flour.
